(19) United States
(12) Patent Application Publication
(10) Pub. No.: US 2015/0271211 A1
(43) Pub. Date: Sep. 24, 2015

(54) RIGHTS MANAGEMENT POLICIES WITH NONTRADITIONAL RIGHTS CONTROL

(71) Applicant: KONICA MINOLTA LABORATORY U.S.A., INC., San Mateo, CA (US)

(72) Inventors: Rabindra Pathak, San Jose, CA (US); Katsuyuki Taima, Redwood City, CA (US); William Chang, Mountain View, CA (US); Akinori Yamamoto, Santa Clara, CA (US)

(73) Assignee: KONICA MINOLTA LABORATORY U.S.A., INC., San Mateo, CA (US)

(21) Appl. No.: 14/222,036

(22) Filed: Mar. 21, 2014

(51) Int. Cl. H04L 29/06; G06F 21/60; G06F 17/30

(52) U.S. Cl. CPC H04L 63/205; G06F 17/30011; G06F 21/604; H04L 63/105

(57) ABSTRACT

A method for managing rights management policies for user access and use of digital documents with nontraditional rights control in addition to traditional rights management services (RMS) based on digital rights management (DRM) policies assigned to respective digital documents and their users and stored in an RMS database, including the steps of: a server, upon receiving a user's request regarding a document protected by one or more DRM policies, determining whether the document has additional nontraditional rights control for the user; the server checking a nontraditional policy service (NPS) database, and validating the user's information with one or more NPS database entries of NPS policy extensions pertaining to the document and the user, where the NPS policy extensions amend the DRM policies with additional nontraditional rights control; and the server denying the user's request if the user's information cannot be validated by anyone of said one or more NPS database entries of the NPS policy extensions pertaining to the document and the user, or granting the user's request if the user's information can be validated by all of said one or more NPS database entries of the NPS policy extensions pertaining to the document and the user.

### BACKGROUND OF THE INVENTION

1. Field of the Invention

This invention relates to a method of managing rights management policies for user access and use of electronic documents, and in particular, it relates to a method for managing rights management policies for user access and use of digital documents with nontraditional rights control.

2. Description of Related Art

As more and more documents are generated, distributed, accessed and used electronically in digital file formats such as the Portable Document Format (PDF), rights management systems (RMS) are increasingly implemented to provide digital rights management (DRM) protection to users' access and use of such digital documents.

Typically, the digital rights involved in using a digital document may include the right to open (or “read/view”) the digital document, the right to edit (or “write”) the digital document, the right to print the digital document hard copies or another digital format, the right to copy the digital document, etc. A user may access a digital document by acquiring (or being assigned) one or more of these rights, and any of the acquired or assigned rights may be later revoked for various reasons.

RMS are implemented to control users' rights to access and use of digital documents, and prevent unauthorized access and use of digital documents. For example, when a user purchases a digital document to read in its electronic format, RMS will allow the use to open the document in, e.g., PDF, while restricting the digital document to be printed in hard copies. Often times RMS protected documents are user-specific. For example, if a first user has paid for a fee to download and read a PDF document, then the PDF document may be associated with the identification (ID) of the first user, and a second user using a different ID may not be able to open and read the PDF file even if the second user obtain a digital copy of the document from the first user.

Conventional RMS are designed and developed with traditional approaches that use digital right policies associated with DRM protected documents and their users. A policy typically specifies a set of digital rights, such as open/read, edit/write, print, copy, etc., and may be assigned to a digital document and/or associated with a specific user. For example, for a digital document D₁, a first associated policy P₁ includes the rights of open/view, edit, print and copy, but a second associated policy P₂ only includes the rights of open/view and print. To manage users' access and use of document D₁, certain users U₁ . . . Uₖ may be assigned to policy P₁ with regard to document D₁, which means that these users can open/view, edit, print and copy document D₁, while other users Uₖ₊₁ . . . Uₘ may be assigned to policy P₂ with regard to document D₁, which means that these other users may only open/view and print document D₁.

There is a need to provide a broader protection to digital documents by controlling users' actions in connection with other additional, nontraditional rights, such as the ones based on users' Internet Protocol (IP) address, users' location, number of devices used simultaneously to open a digital document, the time window granted for accessing a digital document, etc.

### SUMMARY

The present invention is directed to a new method for managing rights management policies for user access and use of digital documents with nontraditional rights control.

The applicants of this invention have observed several real life scenarios that are difficult to handle with conventional RMS. For example, conventional RMS cannot process users' access and use requests and grant permissions of a digital document based on the users' IP or domain address or address range. Another example is that conventional RMS cannot process users' access and use requests and grant permissions of a digital document based on the users' geographic locations and/or language environment. A further example is that conventional RMS cannot process users' access and use requests and grant permissions of a digital document based on the number of simultaneously open copies or print-outs that have already been made to the digital document. Still a further example is that conventional RMS cannot process users' access requests and grant permissions of a digital document based on a time window that is granted for the users to access and use the digital document.

Therefore, an object of the present invention is to solve the problems of the conventional RMS as or similar to the ones discussed above, and provide a method for managing rights management policies for user access and use of digital documents with nontraditional and broader rights control.

Additional features and advantages of the invention will be set forth in the descriptions that follow and in part will be apparent from the description, or may be learned by practice of the invention.

The objectives and other advantages of the invention will be realized and attained by the structure particularly pointed out in the written description and claims thereof as well as the appended drawings.

To achieve these and/or other objects, as embodied and broadly described, one of the exemplary embodiments of the present invention provides a method for managing rights management policies for user access and use of digital documents with nontraditional rights control in addition to traditional RMS based on DRM policies assigned to respective digital documents and their users and stored in an RMS database, including the steps of: a server, upon receiving a user's request regarding a document protected by one or more DRM policies, determining whether the document has additional nontraditional rights control for the user; the server checking a nontraditional policy service (NPS) database, and validating the user's information with one or more NPS database entries of NPS policy extensions pertaining to the document and the user, where the NPS policy extensions amend the DRM policies with additional nontraditional rights control; and the server denying the user's request if the user's information cannot be validated by anyone of said one or more NPS database entries of the NPS policy extensions pertaining to the document and the user, or granting the user's request if the user's information can be validated by all of said one or more NPS database entries of the NPS policy extensions pertaining to the document and the user.

In a further aspect, another one of the exemplary embodiments of the present invention provides a computer software program product that causes a data processing apparatus to perform the above described methods. The computer program product includes a computer usable non-transitory medium (e.g. memory or storage device) having a computer readable program code embedded therein for controlling a data processing apparatus, where the computer readable program code is configured to cause the data processing apparatus to execute the above described processes.

It is to be understood that both the foregoing general description and the following detailed description are exemplary and explanatory and are intended to provide further explanation of the invention as claimed.

### BRIEF DESCRIPTION OF THE DRAWINGS

FIG. 1 is a schematic block diagram illustrating an exemplary online environment according to one of the embodiments of the present invention.

FIG. 2 is a schematic block diagram illustrating an exemplary data processing apparatus such as a computer or server having a data processing unit according to one of the embodiments of the present invention.

FIG. 3 is a flow chart diagram illustrating an exemplary process of adding nontraditional policy extensions to a DRM protected digital document according to one of the embodiments of the present invention.

FIG. 4 is a flow chart diagram illustrating an exemplary process of managing rights management policies for user access and use of digital documents with nontraditional rights control according to one of the embodiments of the present invention.

FIG. 5 is a flow chart diagram illustrating an exemplary process of logging document events such as opening/viewing, printing/copying and closing/exiting a digital document protected by nontraditional rights control according to one of the embodiments of the present invention.

### DETAILED DESCRIPTION OF PREFERRED EMBODIMENTS

Embodiments of the present invention provide a method for managing rights management policies for user access and use of digital documents with nontraditional rights control.

Traditionally, RMS systems have provided digital document protection policies against, e.g., viewing/opening, printing, copying/editing and/or revoking digital documents. The embodiments of the present invention provide a broader protection by controlling action against other nontraditional rights based on, e.g., IP address, location, language, the number of devices used simultaneously to open a digital document, the time window for access and use the digital document, etc. That is, the embodiments of the present invention provides additional coverage of protection by allowing control of the nontraditional rights for accessing and using digital documents.

With the additional control of the nontraditional rights for users' accessing and using of digital documents, many real life scenarios that were difficult to handle by conventional RMS can be addressed now. For example, users' access and use requests and permission grants of digital documents can now be based on the users' IP or domain address or address range, the users' geographic locations and/or language environment, the number of simultaneously open copies or print-outs that have already been made to the digital document, the time window that is granted for the users to access and use the digital document, etc.

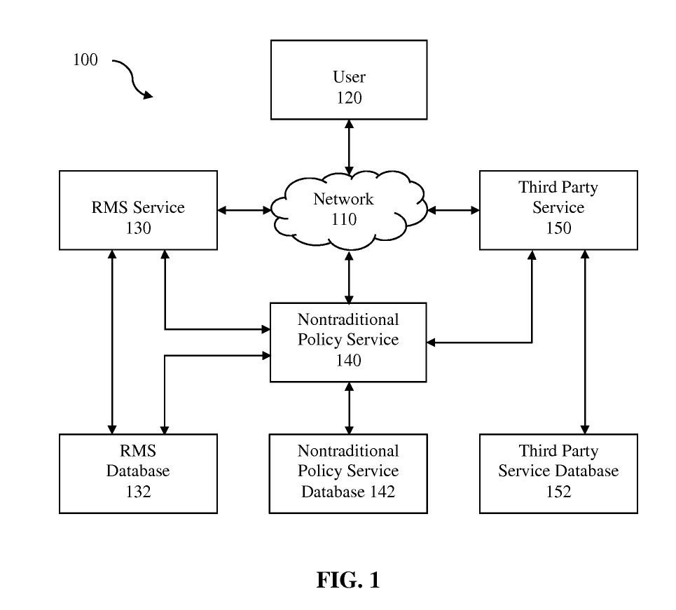

Referring to FIG. 1, there is shown a schematic block diagram illustrating an exemplary arrangement 100 in which various embodiments of the present invention may be implemented in an online environment utilizing a computer network 110 such as the Internet.

The exemplary arrangement 100 includes a user terminal 120, an RMS server 130, a nontraditional policy service (NPS) server 140, and one or more third party servers 150, all connected via the Internet 110. In addition, the NPS server 140 may be directly connected to the RMS server 130 and/or the third party server(s) 150. Moreover, the RMS server 130 is connected to an RMS database 132, the NPS server 140 is connected to a NPS database 142 and the RMS database 132, and the third party server 150 is connected to a third party database 152.

In the online environment 100 shown in FIG. 1, a user may use the user terminal 120, or similar suitable devices such as a laptop computer, a tablet computer, an e-reader, or a smart phone, etc., to access the computer network 110 and interact with the RMS server 130, the NPS server 140, the third party server 150, etc. An administrator or operator may operate the RMS server 130 to access the network 110 and interact with the user through the user terminal 120, and other administrators or operators at the NPS server 140 and the third party server 150. Likewise, an administrator or operator may operate the NPS server 140 to access the network 110 and interact with the user through the user terminal 120, and other administrators or operators at the RMS server 130 and the third party server 150.

The RMS server 130 may be operated by a copyrights management center or DRM center, an online contents provider, an educational institution, etc., and generally provides online electronic documents, books, booklets, publications and other materials in digital files. When an electronic document is purchased by a user in a digital format file such as a PDF file, the RMS server 130 may enable appropriate DRM protection to the document by assigning and/or associating an appropriate policy to the document and/or the user, such that, e.g., only the user who has purchased the document may have rights to access and view the document. The ID of the document and the ID of the user who purchased the electronic document may be saved in the RMS database 132 for future reference.

For example, if the document is available online, then the user who purchased the digital document may access the document at a future time by providing the document ID and his or her user ID, and a search through the RMS database 132 will indicate that the user indeed has the rights to access and view the document.

The NPS server 140 may be operated by, for example, an online content provider, an educational institution, a digital printing service provide or printing house, and generally implements the embodiments of the present invention to provide a broader protection by controlling nontraditional rights for users' access and use of digital documents based on, e.g., IP address, location, language, the number of devices used simultaneously to open a digital document, the time window for access and use the digital document, etc. The additional nontraditional rights assigned or associated with different document and/or user IDs are stored in the NPS database 142, such that a search through the NPS database 142 will indicate that whether certain documents and/or users are subject to the additional nontraditional rights protection.

The third party server or servers 150 may be operated by third party or parties. For example, a third party server 150 may be a geographic location service provider that can convert an IP address to a geographic location of a computer or server with such IP address, and the third party database 152 may be a geographic location database.

The computers, terminals and servers may be computers, server computers, or computer or server systems, such as webservers, where the computer software program(s) and/or application(s) implementing the various processes of the exemplary embodiments of the present invention may be installed and executed.

Typically these computers and servers provide a user interface (UI) or graphic user interface (GUI) to allow users or operators to interact with the computer software programs and applications to perform various steps of the process. A user or operator typically accesses the computers and/or server by using computer programs or applications on the computer or server that the user or operation can access through a computer, server or a terminal.

In this Application the term “server” generally refers to any computer, server, server computer, server instance, computer or server system, data processor, controller, data processing unit or apparatus, or any suitable system, apparatus or device, and any computer software program or application that are installed or executed on such system, apparatus or device, that may be used to implement the methods or carry out the processes provided by the embodiments of the present invention. In addition, the term “user” generally refers to anyone who uses the method or related apparatus provided by the embodiments of the present invention. Furthermore, the terms “user” or “operator” on one hand, and the terms “computer” or “server” used by a user or operator on the other hand, may be used interchangeably to refer to such person or entity who uses a computer or server, or a computer or server that is used by such person or entity, to carry out the steps of the process according to the various embodiments of the present invention.

The physical locations or the commercial relationship among the various parts of the online environment 100 shown in FIG. 1 are not important. For example, the RMS server 130 and the NPS server 140 may be located in the same educational institution, printer service provider, organization or commercial establishment.

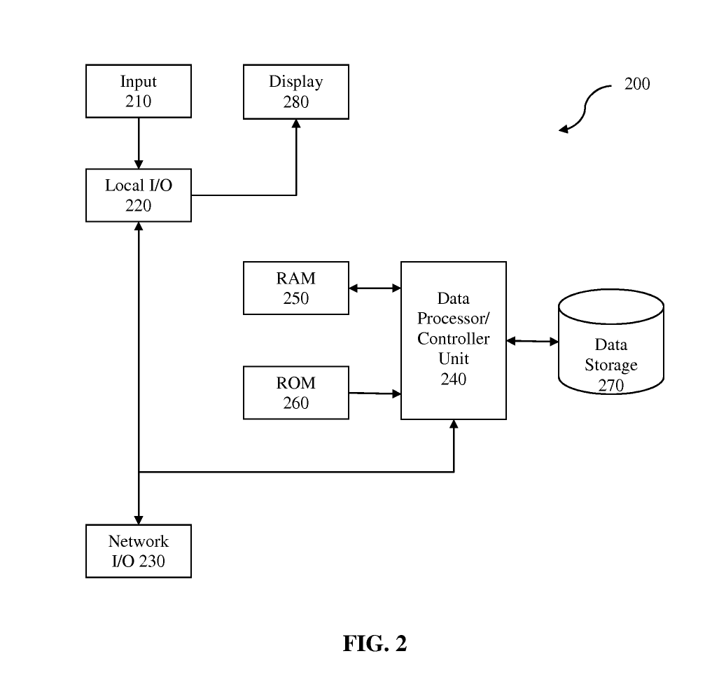

As mentioned earlier, in one aspect, an exemplary embodiment of the present invention is embodied a computer program product that causes a data processing apparatus to perform the exemplary embodiments of the methods of the present invention. The computer program product includes a computer usable non-transitory medium (e.g. memory or storage device) having a computer readable program code embedded therein for controlling a data processing apparatus, where the computer readable program code is configured to cause the data processing apparatus to execute the process of the present invention as shown in FIG. 2.

Referring to FIG. 2, there is shown a schematic block diagram illustrating an exemplary server 200, whereupon various embodiments of the present invention may be implemented. The server 200 typically includes a user input device 210 including, for example, a keyboard and a mouse. The input device 210 may be connected to the server 200 through a local input/output (I/O) port 220 to enable an operator and/or user to interact with the server 210. The local I/O 220 is also provided for local connections via direct links to other electronic devices such as a file storage, a monitor and/or a printer. The server 200 typically also has a network I/O port 230 for connection to a computer network such as the Internet, so that the server 200 may remotely communicate with the other servers connected to the computer network.

The server 200 typically has a data processor/controller unit 240 such as a central processor unit (CPU) that controls the functions and operations of the server 200. The data processor/controller unit 240 is connected to various memory devices such as a random access memory (RAM) device 250, a read only memory (ROM) device 260, and a storage device 270 such as a hard disc drive or solid state memory. The storage device 270 may be an internal memory device or an external memory device such as a file storage device.

The computer software program codes and instructions for implementing the various embodiments of the present invention may be installed or saved on one or more of these memory devices such as the ROM 260 or storage device 270. When executed, certain computer program codes and/or instructions may be read out from the ROM 260 or storage device 270 and temporarily stored in the RAM 250 for execution by the data processor/controller unit 240, which executes these computer programs codes and/or instructions to perform the functions and carry out the operations to implement the process steps of the various embodiments of the present invention.

The server 200 typically also includes a display device 280 such as a video monitor, a display screen or a touch screen which may be connected to the local I/O 220. The input device 210 and the display device 280 together provide a user interface which allows a user to interact with the server 200 to perform the steps of the process according to the various embodiments of the present invention. The input device 210 and the display device 280 may be integrated into one unit, such as a touch screen display unit, to provide a more easy and convenient UI for user interaction with the server 200.

It is understood that the server 200 may be any suitable computer or computer system. Preferably for use, for example, by an RMS provider, a NPS provider or a third party service provider or third party service providers, the server 200 is a commercial server. However, for use by a member of the general public, the server 200 may be a desktop computer, a laptop computer, a notebook computer, a netbook computer, a tablet computer, a hand-held portable computer or electronic device, a smart phone, or any suitable data processing apparatus that has suitable data processing capabilities.

The description in this Application of the structures, functions, interfaces and other relevant features, such as digital rights policies, application programming interface (API) for rights management and policies, etc., of existing DRM method and systems may at times incorporates, references or otherwise uses certain information, documents and materials from publicly and readily available and accessible open sources, e.g., “Rights Management” (URL http://help.adobe.com/en_US/livecycle/10.0/Overview/WS92d06802c76abadb2c8525912ddcb9aad9-7ff8.html), “Programmatically applying policies (a subsection of ‘Rights Management’)” (URL http://help.adobe.com/en_US/livecycle/10.0/Overview/WSb96e41f8a4ca47a9-4882aeb5131190eddba-8000.html), “LiveCycle® ES Java™ API Reference” (URL http://livedocs.adobe.com/livecycle/es/sdkHelp/programmer/javadoc/index.html), etc.

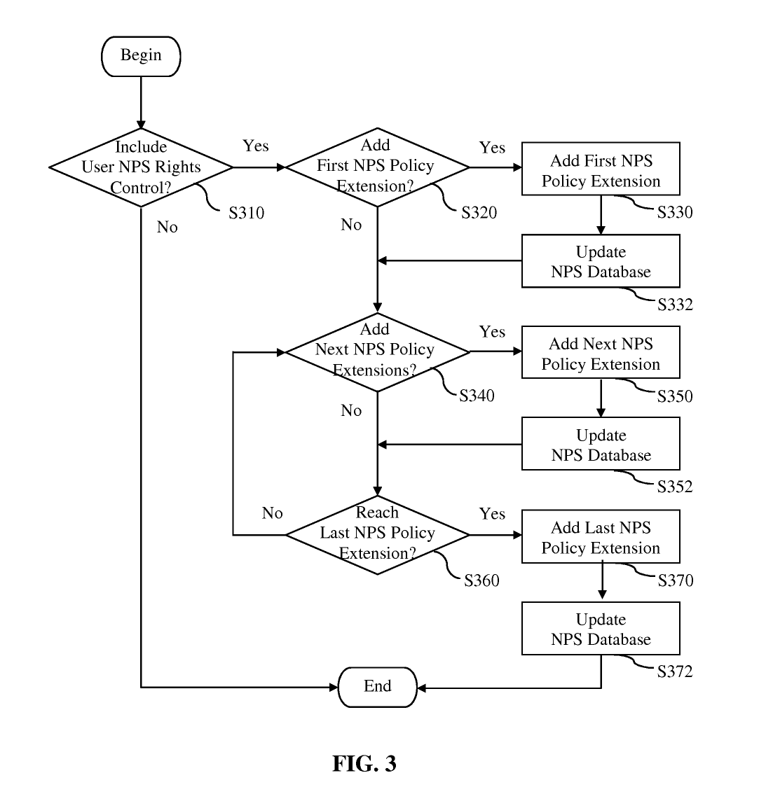

Referring to FIG. 3, there is shown a flow chart diagram illustrating an exemplary process of adding nontraditional policy extensions to a DRM protected digital document according to one of the embodiments of the present invention.

Before additional nontraditional right management may be implemented, the existing document/user policies need to be amended to include NPS policy extensions. That is, when a digital document is protected by RMS, as an initial preparation of the NPS provider, the RMS Server will passes the policy information to the NPS provider, and the NPS provider adds the policy information in the NPS database, and then adds NPS policy extensions related to one or more nontraditional rights.

Such policy extensions, for example, may include the user's IP address range or domain address, local (language), geographic data such as the city, state and country of the user's location, the number of times allowed to open/view a digital document, the actual number of times a digital document has been opened/viewed, the number of times allowed to print/copy a digital document, the actual number of times a digital document has been printed/copied, the number of devices allowed to open simultaneously a digital document, the actual number of device on which a digital document is being opened simultaneously, the valid time window for access and use the digital document, etc. Of course there may be more NPS policy extensions in addition to the ones mentioned above, and some of the NPS policy extensions listed above may be further fine-tuned to more specific needs. For example, the valid time window for access and use of a digital document may be an absolute time window, e.g., from certain date/time to another certain date/time, or a relative time window, e.g., a number of days from an event such as the first opening of the digital document. The exemplary process of adding user specific nontraditional policy extensions to DRM protected digital documents is shown in FIG. 3.

As shown in FIG. 3, at the beginning, the first step S310 is to check whether it is desirable or needed to, for a user U₁, include NPS rights control to a digital document D₁ which already has traditional DRM protection policy P₁. If the answer is “No”, then the process ends. However, if the answer is “Yes”, then at step S320 is to check whether it is desirable or needed to add a first NPS policy extension to digital document D₁ for user U₁. If the answer is “Yes”, then at the next step S330 the first NPS policy extension is added to digital document D₁ for user U₁, and the NPS database is updated at step S332. As an example, the first NPS policy extension may be user U₁'s IP address or domain address.

The next step S340 is to check whether it is desirable or needed to include another one or more NPS policy extensions to digital document D₁ for user U₁. This is also the step when the answer at step S320 is “No”. If the answer is “Yes” at step S340, then at the next step S350 the next NPS policy extension is added to the digital document D₁ for user U₁, and the NPS database is again updated at step S352. As an example, these one or more NPS policy extensions may include user U₁'s local (language), geographic data such as the city, state and country of user U₁'s location, the number of times allowed to open/view digital document D₁, the actual number of times digital document D₁ has been opened/viewed, the number of times allowed to print/copy digital document D₁, the actual number of times digital document D₁ has been printed/copied, the number of devices allowed to open simultaneously digital document D₁, the actual number of device on which digital document D₁ is being opened simultaneously, etc.

The next step S360 is to check whether the last NPS policy extension desired or needed be added to digital document D₁ for user U₁ is reached. This is also the step when the answer at step S340 is “No”. If the answer is no at step S360, then the process goes back to step S340 to add more NPS policy extensions to digital document D₁ for user U₁. However, if the answer is “Yes” at step S360, then at the next step S370 the last NPS policy extension is added to the digital document D₁ for user U₁, and the NPS database is further updated at step S372. As an example, the last NPS policy extension may be the valid time window for user U₁'s access and use digital document D₁.

It can be seen that steps S340-S360 are in fact forming a loop routine that goes through each and every NPS policy extension that is desired or needed to be added to digital document D₁ for user U₁, until the last NPS policy extension is reached.

For user U₁ and document D₁ that has an assigned or associated traditional DRM or RMS rights policy P₁, after the process described above in conjunction with FIG. 3, the entries of the NPS policy extensions to digital document D₁ for user U₁ in the NPS database will, for example, look like the first row of the Table 1 below.

TABLE 1

| | | | IP Address | | | | | # of | # of | # of | # of | Validity |
|---|---|---|---|---|---|---|---|---|---|---|---|---|
| | | | Range/Domain | Local | | | | Opens | Opens | Prints | Prints | Time |
| User | Document | Policy | Address | (Language) | City | State | Country | Allowed | Actual | Allowed | Actual | Window |
| U₁ | D1 | P₁ | 12.3.4.x | Any | Any | Any | Any | Any | | Any | | Jan. 1, 2014 |
| | | | to | | | | | | | | | to |
| | | | 12.3.5.x | | | | | | | | | Jan. 1, 2015 |
| | D₂ | P₂ | 12.3.6.x | English | San | CA | USA | 5 | | 3 | | Jan. 1, 2014 |
| | | | to | | Mateo | | | | | | | to |
| | | | 12.3.7.x | | | | | | | | | Apr. 1, 2014 |
| | D₃ | P₃ | 12.3.8.x | Any | Denver | CO | USA | 3 | | 1 | | Mar. 1, 2014 |
| | | | to | | | | | | | | | to |
| | | | 12.3.9.x | | | | | | | | | Jun. 1, 2014 |
| U₂ | D₁ | P₁ | 12.3.4.x | Any | Any | Any | Any | Any | | Any | | Jan. 1, 2014 |
| | | | to | | | | | | | | | to |
| | | | 12.3.5.x | | | | | | | | | Jan. 1, 2015 |
| | D₂ | P₂ | 12.3.6.x | English | San | CA | USA | 5 | | 3 | | Jan. 1, 2014 |
| | | | to | | Mateo | | | | | | | to |
| | | | 12.3.7.x | | | | | | | | | Apr. 1, 2014 |
| | D₄ | P₄ | 12.4.1.x | Japanese | Any | Any | Japan | Any | | Any | | 10 days |
| | | | to | | | | | | | | | from 1st |
| | | | 12.4.2.x | | | | | | | | | opening |
| U₃ | D₂ | P₂ | 12.3.6.x | English | San | CA | USA | 5 | | 3 | | Jan. 1, 2014 |
| | | | to | | Mateo | | | | | | | to |
| | | | 12.3.7.x | | | | | | | | | Apr. 1, 2014 |
| | D₃ | P₃ | 12.3.8.x | Any | Denver | CO | USA | 3 | | 1 | | Mar. 1, 2014 |
| | | | to | | | | | | | | | to |
| | | | 12.3.9.x | | | | | | | | | Jun. 1, 2014 |
| | D₅ | P₅ | 12.5.1.x | Japanese | Any | Any | Japan | Any | | Any | | Jun. 1, 2014 |
| | | | to | | | | | | | | | to |
| | | | 12.5.2.x | | | | | | | | | Sep. 1, 2014 |
| . . . | . . . | . . . | . . . | . . . | . . . | . . . | . . . | . . . | . . . | . . . | . . . | |

If a user is assigned to more policies for more documents, then the process shown in FIG. 3 will be repeated for each of the document. IN the example shown in Table 1, user U₁ is also assigned to policies P₂ and P₃ for digital documents D₂ and D₃ respectively, so the process shown in FIG. 3 will be repeated for digital document D₂ and D₃ so that both policies will have respective NPS policy extensions added thereto.

In addition, the process shown in FIG. 3 will also be repeated for all users managed by the NPS provider. In the example shown in Table 1, the process shown in FIG. 3 will be repeated for users U₂ and U₃ etc. as well.

It is understood that Table 1 only demonstrates an exemplary NPS database according to the embodiments of the present invention. Other NPS policy extensions, if desired or needed, may be included in the NPS database table.

Once the NPS policy extensions are added for the users and digital documents managed by the NPS provider, the users' access and use of the digital documents are further protected by the NPS, in additional to the traditional DRM protection provided by the RMS provider.

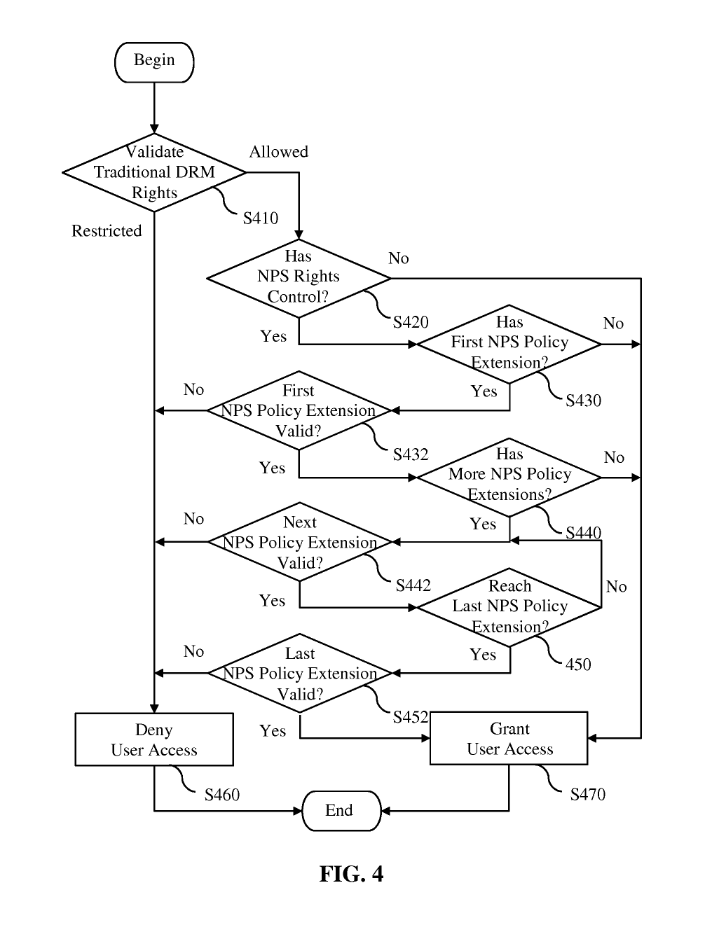

Referring to FIG. 4, there is shown a flow chart diagram illustrating an exemplary process of managing rights management policies for user access and use of digital documents with nontraditional rights control according to one of the embodiments of the present invention. To begin with, when a user U tries to access or perform an action on a DRM protected digital document D, the RMS server will receive an authorization request from user U, and at step S410 will first validate user U's traditional DRM rights according to a traditional DRM protection policy P assigned to or associated with user U and digital document D. If user U's access and use of digital document D is restricted under traditional DRM protection policy P, then the RMS server will deny user U's access to digital document D at step S460, and the process ends.

If user U is allowed to access and use digital document D under traditional DRM protection policy P, then the RMS server will pass user U's authorization request to the NPS server, and at step S420 it will be checked whether additional NPS rights control exist, i.e., whether there are NPS policy extensions added to traditional DRM policy P for user U's access and use of digital document D. If the answer is “No”, then no further restriction remains and the user U will be granted access to digital document D at step S470, and the process ends.

If the answer is “Yes” at step S420, then at step S430, the NPS server will check to see whether the NPS policy extensions to digital document D for user U include a first NPS policy extension. If the answer is “Yes”, then at the next step S432, the NPS server will check the NPS database to see whether the first NPS policy extension can be validated by user U's information. For example, the first NPS policy extension may be allowable IP address range or domain address. If user U's IP or domain address is not within the IP or domain address range specified for the first NPS policy extension pertaining to user U and digital document D as contained in the NPS database, then the answer at step S432 is “No” and user U will be denied access to digital document D at step S460, at which point the process ends.

If the answer at step S432 is “Yes”, then the next step S440 is to check whether there are more NPS policy extensions to digital document D for user U. If the answer is “Yes”, then at the next step S442, the NPS server will check the NPS database to see whether these other NPS policy extensions can be validated by user U's information. As an example, these other NPS policy extensions may include user U's local (language), geographic data such as the city, state and country of user U's location, the number of times allowed to open/view digital document D, the actual number of times digital document D has been opened/viewed, the number of times allowed to print/copy digital document D, the actual number of times digital document D has been printed/copied, the number of devices allowed to open simultaneously digital document D, the actual number of device on which digital document D₁ is being opened simultaneously, etc.

The NPS server may use third party server(s) and database(s) to obtain information for validating the NPS policy extensions. For example, for location verification, the NPS server may uses third party geographic location service such as the “Geo Location Service” which returns user's geographic location (city, state and country) based on user's IP Address.

If user U's information cannot be validated, i.e., does not match with the respective entries of the NPS policy extensions pertaining to user U and digital document D as contained in the NPS database, then the answer as step S442 is “No” and user U will be denied access to digital document D at step S460, at which point the process ends.

If the answer at step S442 is “Yes”, then the next step S450 is to check whether the last NPS policy extension to digital document D for user U has been reached. If the answer is “No”, then the process will go back to step S442 to valid the next NPS policy extension. However, if the answer is “Yes”, then at the next step S452, the NPS server will check the NPS database to see whether the last NPS policy extension can be validated by user U's information. As an example, the last NPS policy extension may be the valid time window for user U's access and use digital document D.

If user U's information cannot be validated, i.e., does not match with the entry of the last NPS policy extension pertaining to user U and digital document D as contained in the NPS database, then the answer as step S452 is “No” and user U will be denied access to digital document D at step S460, at which point the process ends. However, if the answer as step S452 is “Yes” and user U will be granted access to digital document D at step S470, and the user access authentication or verification process ends.

Again, it can be seen that steps S442-S452 are in fact forming a loop routine that goes through each and every NPS policy extension to digital document D for user U, until the last NPS policy extension is reached.

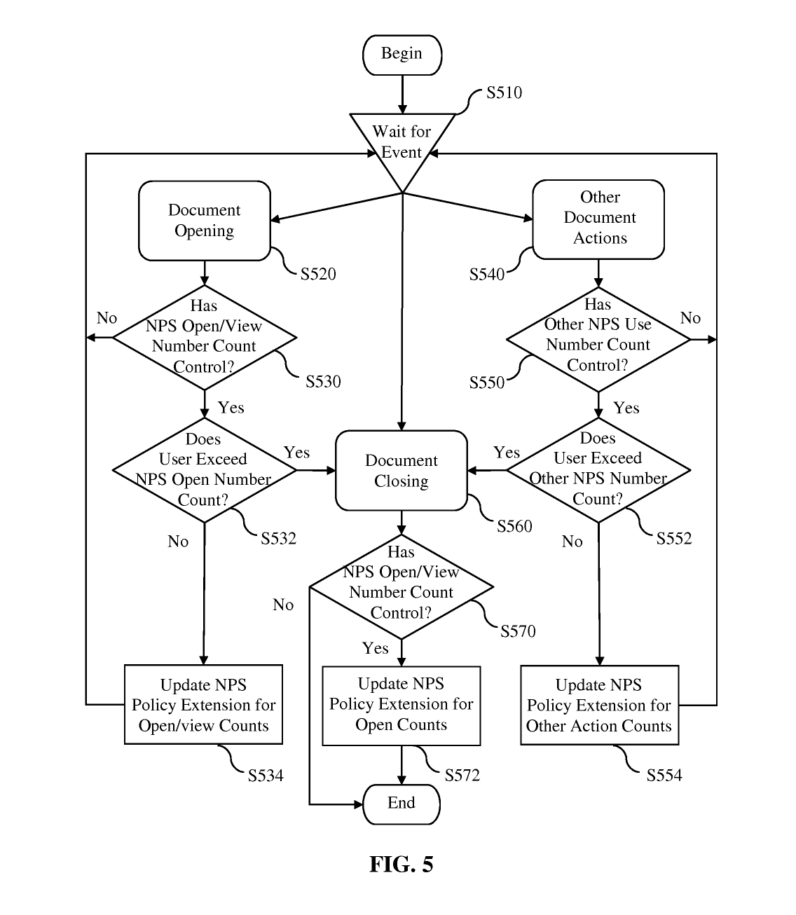

Furthermore, every time a user U opens/views or prints/copies a DRM protected digital document D that is further protected by nontraditional policy extensions, the RMS server gets the document event information (e.g., opening/viewing, printing/copying, and closing digital document D) and passes to the NPS server, whereupon the NPS server then updates the NPS database table with the actual number of times digital document D has been opened/viewed or printed/copied. This updating process is shown in FIG. 5.

Referring to FIG. 5, there is shown a flow chart diagram illustrating an exemplary process of logging document events such as opening/viewing, printing/copying and closing/exiting a digital document protected by nontraditional rights control to update the NPS database according to one of the embodiments of the present invention.

At the beginning, the NPS server will wait for a document event at step S510, such as opening/viewing, printing/copying or closing/exiting a digital document D. At step S520, a document opening event happened, which is user U's opening/viewing of digital document D. At step S530 the process will check to see whether user U has a restriction on the number of times the digital document D can be opened/viewed as part of the NPS policy extension to digital document D for user U. If the answer is “No”, then the process goes back to step S510 (i.e., wait for event). However, if the answer is “Yes”, then at step S532 the process goes on to check whether user U has exceeded his or her allowance for the number of times digital document D may be opened/viewed. If the answer is “Yes”, then the document will be closed at step S560. If the answer is “No”, then the open/view count will be updated in the entries of NPS policy extensions to digital document D for user U in the NPS database.

When a document event is another document action at step S540, such as user U's printing/copying of digital document D. At step S550 the process will check to see whether user U has a restriction on the number of times the digital document D can be printed or copied as part of the NPS policy extension to digital document D for user U. If the answer is “No”, then the process goes back to step S510 (i.e., wait for event).

However, if the answer is “Yes” at step S550, then at step S552 the process goes on to check whether user U has exceeded his or her allowance for the number of times digital document D may be printed or copied. If the answer is “Yes”, then the document will be closed at step S560. If the answer is “No”, then the open/view count will be updated in the entries of NPS policy extensions to digital document D for user U in the NPS database.

When a document event at step S560 is user U's closing of digital document D, at step S570 the process will check to see whether user U has a restriction on the number of times the digital document D can be opened/viewed as part of the NPS policy extension to digital document D for user U. If the answer is “No”, then the process ends. However, if the answer is “Yes”, then at step S572 the open/view count will be updated in the entries of NPS policy extensions to digital document D for user U in the NPS database, and the process ends.

Additional features and advantages of the invention will be set forth in the descriptions that follow and in part will be apparent from the description, or may be learned by practice of the invention. The objectives and other advantages of the invention will be realized and attained by the structure particularly pointed out in the written description and claims thereof as well as the appended drawings.

It will be apparent to those skilled in the art that various modification and variations can be made in the method and related apparatus of the present invention without departing from the spirit or scope of the invention. Thus, it is intended that the present invention cover modifications and variations that come within the scope of the appended claims and their equivalents.

What is claimed is:

1. A method for managing rights management policies for user access and use of digital documents with nontraditional rights control in addition to traditional rights management services (RMS) based on digital rights management (DRM) policies assigned to respective digital documents and their users and stored in an RMS database, comprising the steps of:
a server, upon receiving a user's request regarding a document protected by one or more DRM policies, determining whether the document has additional nontraditional rights control for the user;
the server checking a nontraditional policy service (NPS) database, and validating the user's information with one or more NPS database entries of NPS policy extensions pertaining to the document and the user, where the NPS policy extensions amend the DRM policies with additional nontraditional rights control; and
the server denying the user's request if the user's information cannot be validated by anyone of said one or more NPS database entries of the NPS policy extensions pertaining to the document and the user, or granting the user's request if the user's information can be validated by all of said one or more NPS database entries of the NPS policy extensions pertaining to the document and the user.

2. The method of claim 1, wherein the NPS policy extensions include user's Internet Protocol (IP) address range, domain address, a language used by the user, geographic data such as the city, state and country, the number of times allowed to open a document, the actual number of times a document has been opened, the number of times allowed to print a document, the actual number of times a document has been printed, the number of devices allowed to open simultaneously a document, the actual number of device on which a document is being opened simultaneously, and a valid time window for access the document.

3. The method of claim 1, further comprising a step of generating the NPS database by adding one or more entries of NPS policy extensions.

4. The method of claim 3, further comprising a step of adding one or more entries of NPS policy extensions to each DRM policy assigned to a document.

5. The method of claim 3, further comprising a step of adding one or more entries of NPS policy extensions to each DRM policy assigned to a user.

6. The method of claim 3, wherein the NPS policy extensions include user's Internet Protocol (IP) address range, domain address, a language used by the user, geographic data such as the city, state and country, the number of times allowed to open a document, the actual number of times a document has been opened, the number of times allowed to print a document, the actual number of times a document has been printed, the number of devices allowed to open simultaneously a document, the actual number of device on which a document is being opened simultaneously, and a valid time window for access the document.

7. The method of claim 1, further comprising a step of updating one or more NPS database entries of NPS policy extensions based on an occurrence of a document event.

8. The method of claim 7, wherein the document event is document opening.

9. The method of claim 7, wherein the document event is document printing.

10. The method of claim 7, wherein the document event is document closing.

11. A computer program product comprising a non-transitory computer usable medium having a computer readable code embodied therein for controlling a data processing apparatus, the computer readable program code configured to cause the data processing apparatus to execute a process for managing rights management policies for user access and use of digital documents with nontraditional rights control in addition to traditional rights management services (RMS) based on digital rights management (DRM) policies assigned to respective digital documents and their users and stored in an RMS database, the process comprising the steps of:
a server, upon receiving a user's request regarding a document protected by one or more DRM policies, determining whether the document has additional nontraditional rights control for the user;
the server checking a nontraditional policy service (NPS) database, and validating the user's information with one or more NPS database entries of NPS policy extensions pertaining to the document and the user, where the NPS policy extensions amend the DRM policies with additional nontraditional rights control; and
the server denying the user's request if the user's information cannot be validated by anyone of said one or more NPS database entries of the NPS policy extensions pertaining to the document and the user, or granting the user's request if the user's information can be validated by all of said one or more NPS database entries of the NPS policy extensions pertaining to the document and the user.

12. The computer program product of claim 11, wherein the NPS policy extensions include user's Internet Protocol (IP) address range, domain address, a language used by the user, geographic data such as the city, state and country, the number of times allowed to open a document, the actual number of times a document has been opened, the number of times allowed to print a document, the actual number of times a document has been printed, the number of devices allowed to open simultaneously a document, the actual number of device on which a document is being opened simultaneously, and a valid time window for access the document.

13. The computer program product of claim 11, wherein the process further comprises a step of generating the NPS database by adding one or more entries of NPS policy extensions.

14. The computer program product of claim 13, wherein the process further comprises a step of adding one or more entries of NPS policy extensions to each DRM policy assigned to a document.

15. The computer program product of claim 13, wherein the process further comprises a step of adding one or more entries of NPS policy extensions to each DRM policy assigned to a user.

16. The computer program product of claim 13, wherein the NPS policy extensions include user's Internet Protocol (IP) address range, domain address, a language used by the user, geographic data such as the city, state and country, the number of times allowed to open a document, the actual number of times a document has been opened, the number of times allowed to print a document, the actual number of times a document has been printed, the number of devices allowed to open simultaneously a document, the actual number of device on which a document is being opened simultaneously, and a valid time window for access the document.

17. The computer program product of claim 11, wherein the process further comprises a step of updating one or more NPS database entries of NPS policy extensions based on an occurrence of a document event.

18. The computer program product of claim 17, wherein the document event is document opening.

19. The computer program product of claim 17, wherein the document event is document printing.

20. The computer program product of claim 17, wherein the document event is document closing.
